(19) United States
(12) Patent Application Publication
(10) Pub. No.: US 2017/0122165 A1
(43) Pub. Date: May 4, 2017

(54) APPARATUS FOR DOSING A UREA SOLUTION TO A SELECTIVE CATALYTIC REDUCTION (SCR) CATALYST

(71) Applicant: DSM IP Assets B.V., Heerlen (NL)

(72) Inventor: Armand Alphons Marie Agnes DUIJSENS, Heerlen (NL)

(21) Appl. No.: 15/127,188

(22) PCT Filed: Mar. 18, 2015
(86) PCT No.: PCT/EP2015/055665

§ 371 Date: Sep. 19, 2016

(30) Foreign Application Priority Data
Mar. 24, 2014 (EP) 14161301.8
Nov. 19, 2014 (EP) 14193800.1

(51) Int. Cl. F01N 3/20; H05B 3/58

(52) U.S. Cl. CPC F01N 3/208; H05B 3/58

(57) ABSTRACT

Apparatus for dosing a urea solution to a selective catalytic reduction (SCR) catalyst in the exhaust of an internal combustion engine, the apparatus comprising an injector for injection of the solution in the exhaust and a tube (1) for transporting the solution to the injector, wherein a heating element (2) is in contact with the tube, which heating element is a Positive Temperature Coefficient (PTC) heating element, comprising at least two parallel wires (4.1, 4.2) embedded in a body (3) of a composition, which composition comprises a polymer and an electrically conductive filler.

The invention relates to an apparatus for dosing an urea solution to a selective catalytic reduction (SRC) catalyst in an exhaust of a diesel engine and to a self-regulating heating element.

In order to reduce the NOx emission of diesel engines of for instance trucks and passenger cars a system comprising a SCR catalyst and an apparatus for dosing urea to the catalyst has been introduced. Urea is dosed as a solution in the exhaust of the engine, in general at a place just before the exhaust gases enter the catalyst. Because of the use of the system the diesel trucks do fulfill the Euro VI norm.

The urea solution comprises 32.5 wt. % of urea, the balance being demineralized water. Further the solution is very pure, to avoid problems with the catalyst, such as for example deposits, reducing the affectivity of the catalyst. Such an urea solution is often sold under the trade name AdBlue™. The apparatus for dosing the urea solution comprises a storage tank for the solution, a dosing pump, an injector for injection of the solution into the exhaust system and a tube for the transportation of the solution to the injector. Since the solution solidifies already at −11° C., both the storage tank and the tube are provided with heating elements. For the tube resistance wires are currently used as heating elements. The heating of the solution is rather critical, since it is important the solution does not solidify in any place of the tube, also not under very low temperatures of for example −20° C. It is however also important that not too much heat is generated, because otherwise the formation of gas bubbles and early decomposition of urea may take place.

Different apparatus must be build, having tubes with different length. Because of the above-mentioned criticality, for each tube a specific heating wire must be used, the electrical resistance of the wire being tuned to the length of the tube and the temperature range wherein the tube must operate.

This problem even increases, since next to trucks, also passenger cars must fulfill the Euro VI norm, so that the number of different apparatuses will grow significantly. Next to the use in exhausts for diesel engines it is also possible that the SRC catalysts will be used in exhausts of further internal combustion engines, for instance engines running on compressed natural gas (CNG) or petrol.

In US2013/0299030 a heatable pipe is disclosed suitable for an apparatus for dosing urea to a SCR catalyst. The pipe consists of several polymeric layers, two parallel electrical wires being embedded between two electrical conductive polymeric layers. The system is complicated to produce. The connection of the electrical wires to an electrical source is complicated, and it is still necessary to tune the heating system to the length of the tube. It is also necessary to provide separate heating systems to the fluid connectors of the tube.

Aim of the invention is to solve these problems. This aim is achieved by providing an apparatus for dosing a urea solution to a selective catalytic reduction (SCR) catalyst in the exhaust of an internal combustion engine, the apparatus comprising an injector for injection of the solution in the exhaust and a tube for transporting the solution to the injector, wherein a heating element is in contact with the tube, which heating element is a Positive Temperature Coefficient (PTC) heating element, comprising at least two parallel wires embedded in a body of a composition, which composition comprises a polymer and an electrically conductive filler.

With such a heating element the temperature of the tube can more accurate be controlled and it is not necessary anymore to use different heating elements for each type of apparatus. This makes the production of the apparatus more economic.

Furthermore the tube according to the invention is easily to bend, without the chance that electrical wires separate from the polymer composition of the heating element. Furthermore the tube according to the invention resists vibrations much better than tubes with integrated electrical wires, such as disclosed in US 2013/0299030, because of the separate heating element.

When an electrical charge is put on the parallel wires of the heating element a current starts flowing through the polymer body, so heating the heating element. Because of the temperature rise the polymer composition expands, the distance between the filler particles in the polymer composition increases and so the electrical resistance increases until the composition becomes an insulator. In this way the polymer composition acts as a self-regulating heating material. It is also indicated by Positive Temperature Coefficient (PTC) material.

The PTC characteristics of the polymer composition depend on the type of polymer and the type and amount of electrically conductive filler. PTC compositions are well-known and the person skilled in the art knows how to produce such a heating element. Furthermore these elements are commercially available.

As electrically conductive fillers carbon black, carbon fibers, carbon nanotubes and metal particles may be used. Preferably carbon black is used, more preferably carbon black with a particle size of between 1 and 1000 nm, most preferably between 10 and 100 nm.

The polymer composition may comprise any polymer, as long as the polymer is capable of withstanding the conditions posed to it because of its use in contact with the tube of the dosing system, for example in the vicinity of the exhaust system.

The continuous use temperature is preferably between 125 and 180° C. Furthermore the polymer preferably is flexible, so that the heating element can easily be brought in contact with the tube, preferably even by being wound around the tube.

The heating element and the tube are in contact, so that heat transfer from the heating element to the tube can take place by heat conduction via the interface between the heating element and the tube.

Examples of suitable polymers include cross-linked polyethylene as well as cross-linked or un-cross-linked polyethylene terephthalate (PET), polybutylene therephtalate (PBT), ethylene-tetrafluoroethylene copolymer (ETFE) and thermoplastisch elastomers.

The polymer composition preferably contains a thermoplastic elastomer selected from the group consisting of a copolyester thermoplastic elastomer (TPE-E), a copolyamide thermoplastic elastomer (TPE-A), a copolyurethane thermoplastic elastomer (TPE-U).

### TPE-E/TPE-A

Copolyester thermoplastic elastomers and copolyamide thermoplastic elastomers are thermoplastic polymers with elastomeric properties comprising hard blocks consisting of respectively polyester segments or polyamide segments, and soft blocks consisting of segments of another polymer. Such polymers are also known as block-copolymers. The polyester segments in the hard blocks of the copolyester thermoplastic elastomers are generally composed of repeating units derived from at least one alkylene diol and at least one aromatic or cycloaliphatic dicarboxylic acid. The polyamide segments in the hard blocks of the copolyamide thermoplastic elastomers are generally composed of repeating units from at least one aromatic and/or aliphatic diamine and at least one aromatic or aliphatic dicarboxylic acid, and or an aliphatic amino-carboxylic acid.

The hard blocks typically consist of a polyester or polyamide having a melting temperature or glass temperature, where applicable, well above room temperature, and may be as high as 300° C. or even higher. Preferably the melting temperature or glass temperature is at least 150° C., more preferably at least 170° C. or even at least 190° C. Still more preferably the melting temperature or glass temperature of the hard blocks is in the range of 200-280° C., or even 220-250° C. The soft blocks typically consist of segments of an amorphous polymer having a glass transition temperature well below room temperature and which temperature may be as low as −70° C. or even lower. Preferably the glass temperature of the amorphous polymer is at most −20° C. Still more preferably the glass temperature of the soft blocks is in the range of −20-−60° C., or even −30-−50° C.

Suitably, the copolyester thermoplastic elastomer is a copolyesterester thermoplastic elastomer, a copolycarbonate-ester thermoplastic elastomer, and for a copolyetherester thermoplastic elastomer; i.e. a copolyester block copolymer with soft blocks consisting of segments of polyester, polycarbonate or, respectively, polyether. Suitable copolyesterester thermoplastic elastomers are described, for example, in EP-0102115-B1. Suitable copolycarbonate-ester thermoplastic elastomers are described, for example, in EP-0846712-B1. Copolyetherester thermoplastic elastomers and the preparation and properties thereof are in the art and for example described in detail in Thermoplastic Elastomers, 2nd Ed., Chapter 8, Carl Hanser Verlag (1996) ISBN 1-56990-205-4, Handbook of Thermoplastics, Ed. O. Otabisi, Chapter 17, Marcel Dekker Inc., New York 1997, ISBN 0-8247-9797-3, and the Encyclopedia of Polymer Science and Engineering, Vol. 12, pp. 75-117 (1988), John Wiley and Sons, and the references mentioned therein.

Copolyester thermoplastic elastomers are available, for example, under the trade name Arnitel, from DSM Engineering Plastics B.V. The Netherlands. Suitably, the copolyamide thermoplastic elastomer is a copolyetheramide thermoplastic elastomer. Copolyetheramide thermoplastic elastomers are available, for example, under the trade name PEBAX, from Arkema, France.

The aromatic dicarboxylic acid in the hard blocks of the copolyester thermoplastic elastomer suitably is selected from the group consisting of terephthalic acid, isophthalic acid, phthalic acid, 2,6-naphthalenedicarboxylic acid and 4,4-diphenyldicarboxylic acid, and mixtures thereof. Preferably, the aromatic dicarboxylic acid comprises terephthalic acid, more preferably consists for at least 50 mole %, still more preferably at least 90 mole %, or even fully consists of terephthalic acid, relative to the total molar amount of dicarboxylic acid.

The alkylene diol in the hard blocks of the copolyester thermoplastic elastomer suitably is selected from the group consisting of ethylene glycol, propylene glycol, butylene glycol, 1,2-hexane diol, 1,6-hexamethylene diol, 1,4-butane diol, benzene dimethanol, cyclohexane diol, cyclohexane dimethanol, and mixtures thereof. Preferably, the alkylene diol comprises ethylene glycol and/or 1,4 butane diol, more preferably consists for at least 50 mole %, still more preferably at least 90 mole %, or even fully consists of ethylene glycol and/or 1,4 butane diol, relative to the total molar amount of alkylene diol.

The hard blocks of the copolyester thermoplastic elastomer most preferably comprise or even consist of polybutylene terephthalate segments.

Copolyestherester thermoplastic elastomers have soft segments derived from at least one polyalkylene oxide glycol. Preferably, the polyalkylene oxide glycol is selected from the group consisting of polypropylene oxide glycol homopolymers (PPG), ethylene oxide/polypropylene oxide block-copolymers (EO/PO block copolymer) and poly(tretramethylene)glycol (PTMG), and mixtures thereof.

Copolycarbonate-ester thermoplastic elastomers have soft segments that comprise repeating units derived from an aliphatic carbonate. Suitable aliphatic carbonate units are represented by the formula:

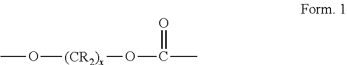

where
R═H, alkyl or aryl,

### X=2-20.

Preferably R═H and x=6, the aliphatic carbonate is therefore hexamethylene carbonate.

The soft segments may also comprise repeating units derived from an aliphatic diol and an aliphatic dicarboxylic acid and/or repeating units derived from a lactone.

The aliphatic diol contains preferably 2-20 carbon atoms, more preferably 3-15 carbon atoms. Most preferably the aliphatic diol is butylene glycol.

The aliphatic dicarboxylic acid preferably contains 2-10 carbon atoms, more preferably 4-15 carbon atoms. Most preferably the aliphatic dicarboxylic acid is adipic acid.

As lactone preferably caprolactone is used.

Preferably at least 40 wt. % of the soft segments consist of the aliphatic carbonate, more preferably at least 60 wt. %, even more preferably at least 80 wt. %, even more preferably at least 90 wt. %, even more preferably at least 95 wt. %, most preferably at least 99 wt. %.

The weight ratio of hard segments:soft segments may be between 20:80 and 90:10, preferably between 30:70 and 80:20, more preferably between 60:40 and 70:30.

One way of producing the copolycarbonate-ester thermoplastic elastomer is described in EP-A-1 964 871. According to this method polyester and aliphatic polycarbonate diols are reacted in the molten state by transesterification.

The hard segments and the soft segments of the copolycarbonate-ester thermoplastic elastomer are preferably connected by a bifunctional urethane group.

Usual bifunctional urethane groups are derived from paratoluene diisocyanate, diphenylmethane diisocyanate (MDI), xylylene diisocyanate, hexanethylene diisocyante or isophorone diiscocyanate. A method for producing the copolycarbonateester by connecting the hard and soft segments by a bifunctional urethane group and further urethane groups useful for that are described in EP-A-0 846 712.

Copolyestheresther thermoplastic elastomers comprise soft segments produced by polycondensation of polyfunctional, preferably bifunctional aliphatic alcohols, amino alcohols, hydroxycarboxylic acids, lactones, aminocarboxylic acids cyclic carbonates or polycarboxylic acids. By choice of the mixing ratio of the above-mentioned compounds any desirable molecular weight and number and type of terminal groups may be obtained.

As examples may be mentioned polyesters from adipic acid and ethylene glycol, butanediol, pentanediol and hexanediol. It is also possible that the soft segment entirely or partly is composed of lactones, such as for example substituted or unsubstituted caprolactone or butyrolactone.

The hard segments and the soft segments of the copolyesterester thermoplastic elastomer are preferably connected by a difunctional urethane group.

The same difunctional urethane groups may be used as used for the copolycarbonate-ester thermoplastic elastomer mentioned above. A method for producing the copolyesterester thermoplastic elastomer by connecting the hard and soft segments by the bifunctional urethane group is described in EP-A-0 102 115.

An advantage of the use of copolycarbonate-ester and copolyesterester thermoplastic elastomers is that the polymer composition of the polymeric body does not need to be cross-linked. Furthermore the electrical power output of the heating element only gradually decreases with increasing temperature, so that the PTC characteristics can be easily tuned.

### TPE-U

The urethane-based thermoplastic elastomer is a resin synthesized by the urethane reaction in which an isocyanate compound is reacted with a compound having active hydrogen, e.g., polyol, optionally in the presence of a chain-extending agent or another additive. It may be produced when the foam is produced or beforehand, or a commercial one.

The isocyanate compounds include aromatic diisocyanates of 6 to 20 carbon atoms (excluding the carbon atom in NCO group), aliphatic diisocyanates of 2 to 18 carbon atoms, alicyclic diisocyanates of 4 to 15 carbon atoms, aromatic aliphatic diisocyanates of 4 to 15 carbon atoms, and modifications thereof (e.g., the modifications containing urethane group, carbodiimide group, allophanate group, urea group, biuret group, urethodione group, urethoimine group, isocyanurate group and oxazolidone group).

More concretely, the isocyanate compounds include tolylene diisocyanate, diphenyl methane diisocyanate, naphthalene diisocyanate, hexamethylene diisocyanate, dicyclomethane diisocyanate, isophorone diisocyanate, xylene diisocyanate, norbornane dimethyl isocyanate and so on.

The compounds having active hydrogen include polyols, polyamine compound, and so on. The concrete examples of polyol compound include ester-based, adipate-based, ether-based, lactone-based and carbonate-based compounds. The chain-extending agents include low-molecular-weight diols, alkylene diamines, or the like.

The ester-based and adipate-based polyol compounds include compounds produced by condensation reaction between a polyhydric alcohol (e.g., ethylene glycol, propylene glycol, butanediol, butenediol, hexanediol, pentanediol, neopentyldiol or pentanediol) and dibasic acid (adipic acid, sebacic acid, azelaic acid, terephthalic acid, isophthalic acid, maleic acid, aromatic carboxylic acid or the like).

The ether-based polyol compounds, for example, include polyethylene glycol, polypropylene ether glycol, polytetramethylene ether glycol, polyhexamethylene ether glycol and so on. The lactone-based polyols include polycaprolactone glycol, polypropiolactone glycol, polyvalerolactone glycol and so on.

The carbonate-based polyols include the compounds obtained by dealcoholization of a polyhydric alcohol (e.g., ethylene glycol, propylene glycol, butanediol, pentanediol, octadiol, nonanediol or the like) with a compound, e.g., diethylene carbonate or dipropylene carbonate.

The commercial urethane-based thermoplastic elastomers include, for example, Pellethane 2103 series (PTMG ether type), 2102 series (caproester type), 2355 series (polyester adipate type) and 2363 series (PTMG ether type) (trade names of Dow Chemical); Resamine P-1000 and P-7000 series (adipate ester type), P-2000 series (ether type), P-4000 series (caprolactone type) and P-800 series (carbonate type) (trade names of Dainichiseika Color and Chemicals); Pandex T series (trade name of DIC Bayer Polymer); Miractone E and P types (trade names of Nippon Miractone); Estolan (trade name of Takeda Burdaysh Urethane); and Morcene (trade name of Morton). They are hereinafter sometimes referred to as thermoplastic polyurethane elastomers (TPU).

Most preferably the polymer composition contains a thermoplastic elastomer comprising urethane groups. This is because the durability of the heating element increases considerably with the use of these polymers in the polymer composition.

Preferably polycarbonateesther elastomer and polyestheresther elastomer with urethane bonding groups are used.

The heating element may comprise more than two parallel electrical wires. Preferably the heating element comprises two parallel electrical wires. Preferably the heating element has an oblong shape. Most preferably the heating element has a ribbon shape. This enables to create a good contact between the surface of the tube and the heating element, to provide an optimal heat transfer from the element to the tube.

The heating element may be applied in the longitudinal direction, parallel to the axis of the tube, in contact with the surface of the tube. It is also possible to apply two or even more heating elements in this way. The heating elements may simply be kept in place by winding a tape around the tube and the heating element or heating elements.

Preferably the heating element has been wound around the tube. This automatically ensures a proper contact between the heating element and the tube, to provide heat transfer. More preferably the heating element has been wound in a spirally fashion, even more preferably in a spirally fashion and the subsequent windings of the element being in contact. In this way the heating element also acts as a heat insulator for the tube.

The heating element preferably comprises a cover of an electrically insulator, such as a polymeric cover. In this way the heating element may be applied to the tube, without further precautions.

The invention also relates to an assembly of the tube for transporting the urea solution to the injector and at least at one of the ends of the tube a connector, both the tube and the connector being in contact with the heating element.

In this way it is not necessary to take special measures to heat the connector, while if a tube is used having integrated electrical wires as disclosed in US2013/0299030, this is necessary. Preferably the assembly comprises a connector at both ends of the tube, both the tube and the connectors being in contact with the same heating element.

The invention also relates to a heating element comprising two or more parallel wires embedded in a polymeric body of a polymer composition comprising an electrically conductive filler, the polymer composition comprising a copolycarbonate-ester thermoplastic elastomer and/or a copolyesterester thermoplastic elastomer as defined above, preferably comprising urethane bonding groups. The heating element according to the invention shows a high durability, it especially can withstand many heating and cooling cycles. This is probably due to a good adhesion of the electrical wires and the polymer composition of the body of the heating element.

The invention also relates to passenger cars comprising an internal combustion engine and an apparatus according to the invention. For use in passenger cars the invention is extra suitable as explained above.

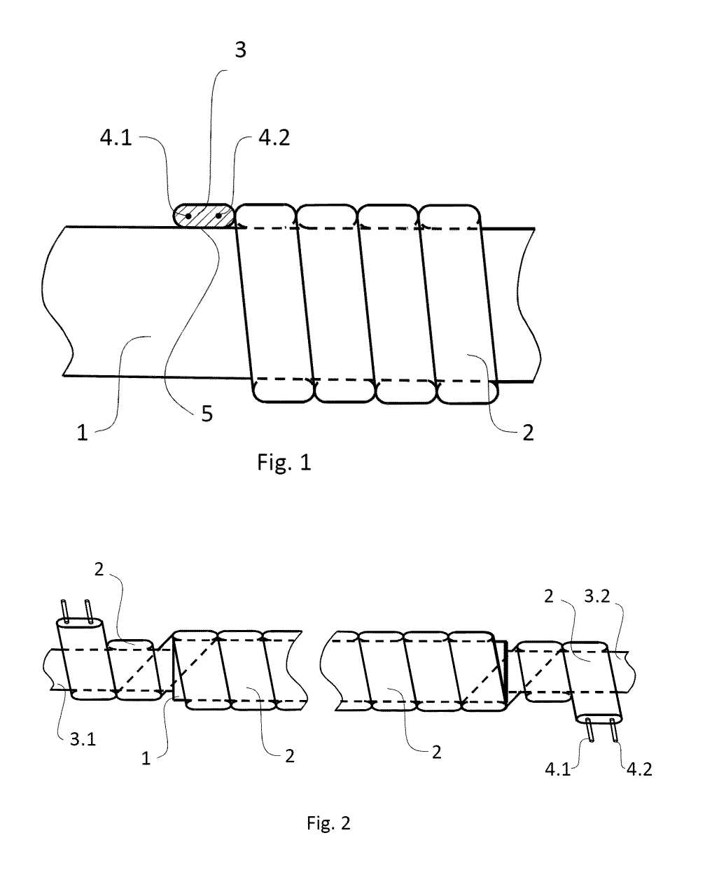

The invention is further explained by the Figure, without being restricted to that. FIG. 1 shows a section of the tube (1) for exporting the injection fluid to the injector and a heating element wound around the tube, FIG. 2 shows an assembly of the tube of FIG. 1, and two connectors.

FIG. 1 shows a section of the tube (1) for exporting the injection fluid to the injector (not shown). A heating element (2) has been wound around the tube, in a spirally fashion and the subsequent windings of the element being in contact. In a cut through the electrical wires (4.1 and 4.2) embedded in a body (3) of a composition comprising a polymer and an electrically conductive filler are shown. Furthermore the contact area (5) between the heating element and the surface of the tube is indicated.

FIG. 2 shows an assembly of a tube (1) for exporting the injection fluid to the injector and two connectors. (3.1 and 3.2). A heating element (2) has been wound around the tube and the connectors Indicated are the electrical wires (4.1 and 4.2) embedded in a body (3) of a composition comprising a polymer and an electrically conductive filler and also the contact area (5) between the heating element and the surface of the tube is indicated. It is shown that the heating element also has been brought in contact with the two fluid connectors (3.1 and 3.2).

1. An apparatus for dosing a urea solution to a selective catalytic reduction (SCR) catalyst in the exhaust of an internal combustion engine, the apparatus comprising an injector for injection of the solution in the exhaust and a tube for transporting the solution to the injector, wherein a heating element is in contact with the tube, which heating element is a Positive Temperature Coefficient (PTC) heating element, comprising at least two parallel wires embedded in a body of a composition, which composition comprises a polymer and an electrically conductive filler.

2. An apparatus according to claim 1, wherein the composition comprises a thermoplastic elastomer.

3. An apparatus according to claim 1, wherein the composition contains a thermoplastic elastomer selected from the group consisting of a copolyester thermoplastic elastomer (TPE-E), a copolyamide thermoplastic elastomer (TPE-A), a copolyurethane thermoplastic elastomer (TPE-U).

4. An apparatus according to claim 3, wherein the copolyester thermoplastic elastomer is a copolycarbonate-ester thermoplastic elastomer or a copolyesterester thermoplastic elastomer.

5. An apparatus according to claim 4, wherein the copolycarbonate-ester thermoplastic elastomer or copolyesterester thermoplastic elastomer contains urethane bonding groups.

6. An apparatus according to claim 1, wherein the heating has been wound around the tube.

7. Assembly of the tube for transporting the urea solution to the injector and at least at one of the ends of the tube a connector, both the tube and the connector being in contact with the heating element.

8. Heating element comprising two or more parallel wires embedded in a polymeric body of a composition comprising a polymer and an electrically conductive filler, the composition comprising a copolycarbonate-ester thermoplastic elastomer or a copolyesterester thermoplastic elastomer.

9. Heating element according to claim 8, wherein the copolycarbonate-ester thermoplastic elastomer or copolyesterester thermoplastic elastomer contains urethane bonding groups.

10. Passenger car comprising an internal combustion engine and an apparatus according to claim 1.

11. Apparatus according to claim 1, and passenger car, wherein the internal combustion engine is a diesel engine.
